(19) United States
(12) Patent Application Publication
(10) Pub. No.: US 2019/0194549 A1
(43) Pub. Date: Jun. 27, 2019

(54) SYSTEM AND PROCESS FOR CONVERTING HEAVY OILS TO LIGHT LIQUID PRODUCTS AND ELECTRIC POWER

(71) Applicant: ExxonMobil Research and Engineering Company, Annandale, NJ (US)

(72) Inventor: Walter E. Dubois, Houston, TX (US)

(21) Appl. No.: 16/191,505

(22) Filed: Nov. 15, 2018

Related U.S. Application Data
(60) Provisional application No. 62/609,445, filed on Dec. 22, 2017.

(51) Int. Cl. C10G 9/32; C10G 9/00; C10B 55/10; C10B 57/02; H02K 7/18

(52) U.S. Cl. CPC C10G 9/32; C10G 9/005; C10B 55/10; C10G 2300/708; H02K 7/1823; C10G 2300/1044; C10B 57/02

(57) ABSTRACT

The present invention relates to a system and a process for converting heavy oils into light hydrocarbon products and electric power. The system comprises a CFB reactor for thermal cracking of heavy oils to generate light hydrocarbon products, coupled with a CFB boiler power plant for converting coke particles produced in the CFB reactor into flue gas and then producing steam for generation of electric power. The system and process of the present invention efficiently produces valuable products from heavy oils (electric power and a full range of hydrocarbon products ranging from Heavy Coker Gas Oil to refinery fuel gas) with negligible coke production and minimal or no generation of low heating value gas.

### CROSS-REFERENCE TO RELATED APPLICATIONS

This application claims priority to U.S. Provisional Application Ser. No. 62/609,445 filed Dec. 22, 2017, which is herein incorporated by reference in its entirety.

### FIELD

The present invention relates to a fluid coking process and more particularly to an improved fluid coking process in which a circulating fluid bed reactor for converting heavy oils to light liquids is coupled with a circulating fluid bed boiler power plant for generating electricity.

### BACKGROUND

Circulating fluid bed (CFB) reactors are known devices that can be used to carry out a variety of multiphase chemical reactions. In this type of reactor, a fluid (gas or liquid) is passed through a granular solid material at velocities high enough to suspend the solid and cause it to behave as though it were a fluid. Fluidization is maintained by means of fluidizing gas such as air, steam or reactant gas injected through a distributor (grid, spargers or other means) at the base of the reactor. CFB reactors are now used in many industrial applications, among which are catalytic cracking of petroleum heavy oils, olefin polymerization, coal gasification, and water and waste treatment. A typical application is found in the fluidized bed coking process known as fluid coking and its variants, including Flexicoking™. Another application is in the field of CFB boiler power plants, where coal, petroleum coke or other organic materials are burned in the presence of limestone to reduce sulfur oxide (SOx) emissions; the hot flue gas generated via combustion is used to generate steam and subsequently, electric power.

In fluid coking processes (such as Flexicoking™), a heavy oil charge stock, such as a vacuum residuum, is fed to a coking zone containing a fluidized bed of hot solid particles, usually coke particles, sometimes referred to as seed coke. The heavy oil undergoes thermal cracking in the coking zone resulting in conversion products which include a cracked vapor fraction and coke particles. The coke particles are deposited on the surface of the seed coke particles and a portion of the coked-seed particles is sent from the coking zone to a heating zone which is maintained at a temperature higher than that of the coking zone. Some of the coke particles are burned off in the heating zone, also referred to as a burner or heater, and hot seed particles from the heating zone are returned to the coking zone as regenerated seed particles, serving as the primary heat source for the coking zone.

In the variant of the fluid coking process developed by Exxon Research and Engineering known as Flexicoking™, a portion of the hot coke particles from the heating zone are circulated back and forth to a gasification zone which is maintained at a temperature greater than that of the heating zone. In the gasifier, virtually all of the coke particles are burnedor gasified in the presence of oxygen (via air injection) and steam to generate low heating value fuel gas (or low-BTU gas, “LBG”), which is passed to the burner/heater to increase temperature in that zone and used as refinery fuel. Fluid coking processes, with or without an integrated gasification zone, are described in U.S. Pat. Nos. 3,726,791 and 4,213,848, among others.

In the context of relatively low natural gas prices in many parts of the world, LBG generated in the Flexicoking™ process has become a less attractive commodity for refiners. It can also be burdensome to retrofit a refinery for LBG distribution and firing, and even grassroots refineries may need to factor in additional costs associated with LBG firing. Although there is generally no LBG generated in fluid coking, its main drawback is a high coke production rate, which forces refiners to find a disposition for this stream. In addition, electric power generation via Flexicoking™ and fluid coking is not particularly efficient.

Thus, there is a need for an improved continuous heavy oil conversion system and process in which heavy oils are efficiently converted to more valuable liquid products, e.g., light hydrocarbon products, and electic power, with negligible coke and/or LBG production.

### SUMMARY

The present invention in one aspect provides a system for converting a heavy oil feed. The system comprises a CFB reactor coupled with a CFB boiler power plant. In particular, the system comprises:

a reactor comprising:

a coking zone containing a fluidized bed of solid particles, into which the heavy oil feed is introduced and subjected to thermal cracking to form light hydrocarbon vapors and coke particles with hydrocarbons adhered thereto;

a scrubbing zone, located above the coking zone, for scrubbing the light hydrocarbon vapors;

a stripping zone, located at the bottom of the coking zone, for stripping off at least a portion of the hydrocarbons adhered to the coke particles to form stripped coke particles;

a furnace connected to the stripping zone for receiving at least a portion of the stripped coke particles, in which the stripped coke particles are combusted to form a stream comprised of flue gas and coke fines;

at least one fines separator connected to the furnace for receiving at least a portion of the stream formed in the furnace and separating the coke fines from the flue gas; and

at least one heat-exchange means for exchanging the heat of the separated flue gas with water and/or steam to form a heated steam for generation of electric power. The heat exchange means can be in the furnace, or downstream of the furnace, or in both places.

In another aspect the present invention provides a process for converting a heavy oil feed to low boiling hydrocarbons and electric power, comprising:

(i) introducing a heavy oil feed into a coking zone containing a fluidized bed of solid particles and subjecting the feed to thermal coking conditions in the coking zone to produce lighter hydrocarbon vapors and coke particles with hydrocarbons adhered thereto;

(ii) passing at least a portion of the lighter hydrocarbon vapors through a scrubbing zone;

(iii) passing the coke particles from the coking zone to a stripping zone and stripping the hydrocarbons from the coke particles to form stripped coke particles,

(iv) passing the stripped coke particles to a furnace (which may contain a heat exchange means to produce heated steam) and combusting at least a portion of the stripped coke particles to form a stream comprised of flue gas and coke fines;

(v) passing at least a portion of the stream of step (iii) to at least one fines separator and separating the coke fines from the flue gas in the stream; and

(vi) passing the separated flue gas from the at least one fine separator to a heat-exchange means and exchanging the heat of the flue gas with water and/or steam to form a heated steam for electric power generation.

With the use of the system and method of the present invention, light hydrocarbons can be produced with high yields by thermal cracking in the CFB reactor, while the coke particles formed as a byproduct of thermal conversion can be more efficiently converted to low-sulfur flue gas and then steam to generate electricity. Certain emerging trends give the present invention advantages over the current state of the art. For example, there are increasing requirements relating to production and storage of petroleum coke—the present invention generates minimal or negligible amounts of this generally undesirable byproduct. In addition, with certain changes in regulatory requirements, it is anticipated that refiners will look to investing in heavy oil thermal conversion technologies, and many will seek alternatives to the current state of the art, whether due to unwanted coke production with delayed coking and fluid coking, or the high cost of entry and LBG disposition issues often associated with Flexicoking™. Moreover, with increasing demand for electric power, the present invention is designed for efficient power generation, which is advantageous over the current state of the art heavy oil upgrading technologies.

Other objects, features, and advantageous of the present invention will be more fully appreciated by reference to the following detailed description of the currently preferred, but nonetheless illustrative, embodiments of the present invention, taking in conjunction with the accompanying drawings.

### BRIEF DESCRIPTION OF DRAWINGS

FIG. 1 is a simplified schematic of a fluid coking system as described in U.S. Pat. No. 5,176,819.

FIG. 2 is a simplified illustrative schematic of a fluid coking system of the present invention.

### DETAILED DESCRIPTION

Any heavy hydrocarbonaceous oil which is typically fed to a coking process can be used in the present fluid cokers. Generally, the heavy oil will have a Conradson Carbon Residue (ASTM D189-06e2) of between 5 and 40 wt. % and a Normal Boiling Point above 500° C., and more usually above 540° C. or even higher, e.g. 590° C. Suitable heavy oils include heavy petroleum crudes, reduced petroleum crudes, petroleum atmospheric distillation bottoms, petroleum vacuum distillation bottoms, pitch, asphalt, bitumen, liquid products derived from coal liquefaction processes, including coal liquefaction bottoms, and mixtures of these materials.

Properties of suitable feeds for fluid coking units typically fall within these ranges:

| | | |
|---|---|---|
| Conradson Carbon | 5 to 40 | wt. % |
| Sulfur | 1.5 to 8 | wt. % |
| Hydrogen | 9 to 11 | wt. % |
| Nitrogen | 0.2 to 2 | wt. % |
| Carbon | 80 to 86 | wt. % |
| Metals | 1 to 2000 | ppm |

| | |
|---|---|
| Normal Boiling Point | 340° C.-650° C. |
| API Gravity | −10 to 35° |

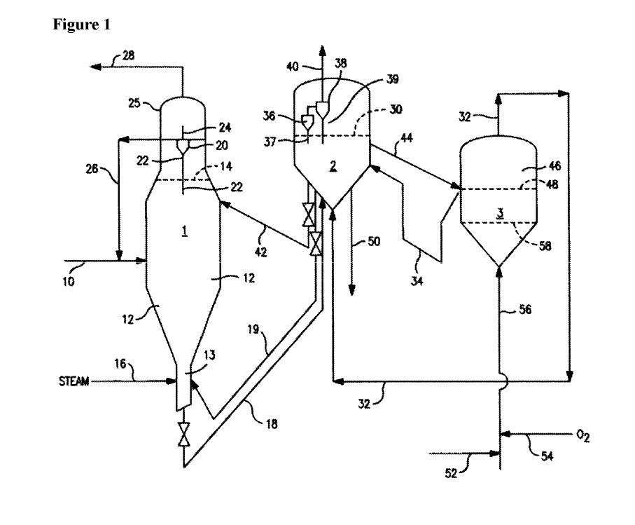

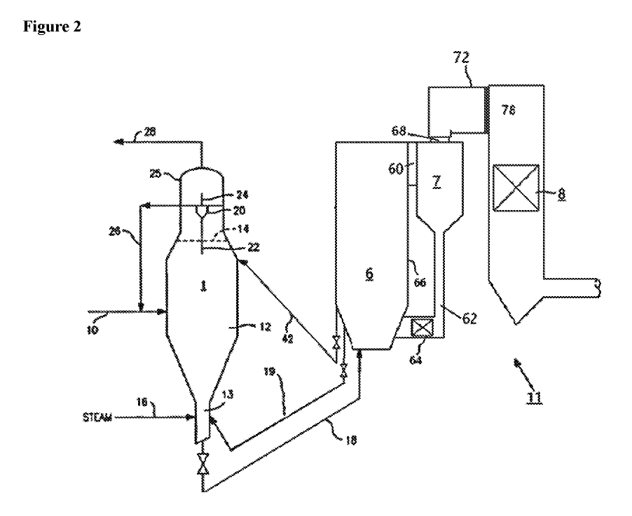

FIG. 1 shows an integrated coking/gasification unit where most of the coke is gasified with a mixture of steam and air in a gasification zone, as shown in in U.S. Pat. No. 5,176,819. FIG. 2 shows a coupled CFB reactor and CFB boiler of the present invention.

As shown in FIGS. 1 and 2, a heavy oil feed stream is passed via conduit 10 to the reaction or coking zone 12 of reactor 1, which contains a fluidized bed of hot seed particles having an upper level indicated at 14. Although the seed material will normally be coke particles, they may also be other materials present, including silica, alumina, zirconia, magnesia, alumina or mullite. They may also be synthetically prepared or naturally occurring materials, such as (for example) pumice, clay, kieselguhr, diatomaceous earth, and bauxite. The seed particles preferably have an average particle size of about 40 to 1000 microns, preferably from about 40 to 400 microns.

The lower portion of reactor 1, constituting stripping zone 13, has the purpose of removing hydrocarbons from the coke particles. A fluidizing gas e.g. steam, is admitted at the base of reactor 1, through conduit 16, into stripping zone 13 of the reactor to produce a superficial fluidizing gas velocity in the seed particles. The velocity is typically in the range of 0.1 to 5 m/sec.

The feed undergoes thermal cracking reactions in the reactor in the presence of the hot seed particles to form cracked hydrocarbon vapors and fresh coke particles containing hydrocarbons on the fluidized seed particles. Vaporous conversion (cracking) products pass through reactor cyclone 20 to remove entrained solids, which are then returned to the coking zone 12 through cyclone dipleg 22. The vapors leave the cyclone through conduit 24, and pass into a scrubbing zone 25 mounted on the top of the coking reactor. The scrubbing zone is useful for scrubbing the lower boiling or light hydrocarbon vapors of coke fines and condensing heavier hydrocarbon vapors. A stream of heavy materials condensed in the scrubbing zone may be recycled to the coking reactor via conduit 26. The coker conversion products are removed from scrubbing zone 25 via conduit 28 for fractionation and liquid hydrocarbon products recovery, in the conventional manner.

Various modifications to the configuration of the coker reactor have been made over the years in an attempt to achieve higher liquid yields and/or alleviate fouling problems in the reactor. For Example, Patent Application Publication No. U.S. 2011/114468 describes the use of perforated sheds in the stripping zone, U.S. 2011/0206563 describes the use of downwardly sloping frusto-conical baffles in the coking zone to the same end, and U.S. 2014/251783 describes the use of a centrally-apertured annular baffle at the top of the stripping zone below the coking zone to inhibit recirculation of solid particles from the stripping zone to the coking zone, contents of which are all incorporated herein by reference. Other modifications to the coking process in the reactor were also proposed over the years to increase yields, for example, U.S. Pat. No. 4,378,288 discloses a method for increasing coker distillate yield in a coking process by adding a free radical inhibitor, and U.S. Pat. No. 5,176,819 describes a process to run the stripping zone at a higher temperature than the coking zone by feeding a portion of the heated solids from the burner/heater (and gasifier if applicable) to the stripping zone, contents of which are also all incorporated herein by reference.

In a typical Flexicoking™ process, as shown in FIG. 1, the coke particles are partially stripped of hydrocarbons in the stripping zone 13 by use of steam and carried via conduit 18 to the heating zone 2, also referred to here as a burner or heater, where they are introduced into the fluidized bed of hot seed/coke particles up to an upper level indicated at 30. In the heater, some combustion of the coked particles takes place. A portion of the hot coke is recycled from heater 2 to coking zone 12 through recirculation conduit 42 to supply the heat required to support the endothermic cracking reactions. A portion of the hot seed/coke from the heating zone is passed via conduit 19 to the top of the stripping zone 13, which helps provide a higher temperature in the stripping zone 13 than the coking zone 12, thereby improving liquid yields without affecting stripper efficiency. The gaseous effluent of the heater 2, including entrained solids, passes through a cyclone system comprising primary cyclones 36 and secondary cyclones 38, in which at least a portion, for example, of the vast majority of the solids are removed from the gas stream. The separated solids are returned to the heater bed via the cyclone diplegs 37 and 39. The heated gaseous effluent which contains entrained solids is removed from the heater 2 via conduit 40. Another portion of coke is removed from heater 2 and passed by conduit 44 to the gasification zone 46 in gasifier 3, in which is maintained a bed of fluidized coke particles having a level indicated at 48 where the hot coke is converted to a fuel gas by partial combustion in the presence of steam in an oxygen-deficient atmosphere. Any remaining portion of excess coke may be removed from heater 2 by conduit 50 as fluid coke by-product. The temperature in the fluidized bed in heater 2 is partly maintained by passing gas from gasifier 3 into the heater by way of conduit 32. Supplementary heat may be supplied to the heater by hot coke recirculating from gasifier 3 through return conduit 34. Steam by conduit 52, and a molecular oxygen-containing gas, such as air, commercial oxygen, or air enriched with oxygen by conduit 54, pass via conduit 56 into gasifier 3. The product gas from the gasifier, which may further contain some entrained solids, is removed overhead from gasifier 3 by conduit 32 and introduced into heater 2 to provide a portion of the required heat as previously described or sent to the refinery fuel gas system for use elsewhere.

In the present application, as shown in FIG. 2, the CFB reactor and its configuration can be the same or similar as that shown in FIG. 1. In the present invention the coke particles that are at least partially stripped of hydrocarbons in stripping zone 13 are carried via conduit 18 to the furnace 6 of a circulating fluid bed (CFB) boiler 11. Limestone, which is used as a sulfur sorbent, is also fed to furnace 6 for SOx removal. Typically the efficiency of SOx removal can be at least 90%, or at least 95%, or higher. The temperature of furnace 6 can be in the range of 1400 to 1700° F. Furnace 6 may have a rectangular cross section, as shown in FIG. 2. The temperature of the furnace can be controlled by in situ steam generation, for example, via boiler feedwater tubes lining the furnace wall. At least one fines separator 7 is connected by at least one flue gas discharge channel 60 to the sidewall 66 of furnace 6. The number of fines separators 7 on each sidewall can be, for example, one, two, three, four, or greater than four. In small and medium size CFB boilers, having typically a capacity of about 300 MWe or less, there are usually from one to four fines separators, which are all arranged on one sidewall of the furnace 6. In larger CFB boilers, having typically a capacity of more than about 300 MWe, multiple fines separators are connected in parallel to each of the two opposite sidewalls of furnace 6. Fines separators 7 are typically cyclone separators, but can be of other types as well.

When the stripped coke particles are combusted in furnace 6, hot flue gas and coke fines entrained therewith are generated and discharged through flue gas discharge channel 60 to fine separators 7. The combustion efficiency of the furnace is typically greater than 95%, for example, at least 98%, at least 99%, or about 100%. Uncombusted coke particles and coke fines are separated from the flue gas in the fine separators 7 and returned back to the lower portion of furnace 6 via return ducts 62. The return ducts 62 may advantageously comprise heat exchange surfaces 64 to recover heat from the recycled hot coke particles/fines. As in the Flexicoking™ process, heated coke particles/fines from furnace 6 can be sent back to the coking zone 12 through recirculation conduit 42, in an amount sufficient to maintain desired temperature in coking zone 12. Temperature in furnace 6 is controlled via in situ steam generation (boiler tubes are affixed to the furnace wall as in a conventional steam-generating boiler).

Optionally, a portion of the hot coke particles/fines from furnace 6 are passed via conduit 19 to the top of the stripping zone 13. This allows the temperature of the stripping zone to be controlled independently of the temperature of the coking zone so as to maintain the temperature of the coking zone below that of the stripping zone to achieve higher liquid yields without sacrificing stripper efficiency. In some embodiments, the temperature of stripping zone 13 is at least 1° C., at least 3° C., or at least 5° C., for example, 5to 15 ° C. higher than that of the coking zone 12. Besides improving fluidization in the stripping zone, the increase in the stripping zone temperature also improves stripping of the hydrocarbons adhered to the coke particles to increase liquid yield and reduces fouling. In some embodiments, the top of the stripper comprises an annular baffle to better segregate the stripping zone from the coking zone.

Streams of cleaned flue gas from fines separators 7 are conducted through a flue gas duct system 72 to a pass 78. The flue gas duct system 72 may have different configurations and the present invention is not prescriptive regarding them. For example, International Patent Application Publication No. WO2010/116039 describes a flue gas duct system comprising at least three crossover ducts having identical cross sections, which provides nearly identical pressure drop for the flue gas exiting furnace 6, and thus helps obtain a uniform and optimized combustion process in the furnace 6. Pass 78 comprises heat exchange means 8 for transferring heat from the flue gas to a heat transfer medium, e.g., water and/or steam to generate a heated steam, which is then routed to a steam turbine generator (not shown) for power generation, as it is commonly done in CFB boiler power plants. In FIG. 2, one heat exchange means 8 is shown symbolically, but in practice there are usually several heat exchange surfaces, such as superheaters, reheaters, economizers, air heaters, etc.

The cooled flue gas is conducted from pass 78 further to gas cleaning stages, such as a dust collector and, if required, a wet gas scrubber (not shown in FIG. 2) for pollutant removal before being released to the atmosphere through a stack or other means. Carbon dioxide capture and sequestration can also be applied to the cooled flue gas as required.

The configuration, layout, and supporting structures of the furnace 6, the fine separator(s) 7, the flue gas duct system 72, the heat exchange means 8, and other auxiliary apparatus (not shown) are not particularly restricted in the present invention and can be any of the variants developed in the art. Example arrangements of these devices can be seen in the International Application Publication No. WO 2010/116039 and WO 2015/185796, the contents of which are incorporated herein by reference.

The present invention minimizes or eliminates the generation of LBG as would occur in a conventional Flexicoking™ unit. In the present invention, coke particles resulting from thermal cracking in the CFB reactor are conducted to the furnace (also termed the ‘boiler’) of a CFB boiler power plant. In the furnace, the vast majority of these coke particles are combusted and the ensuing flue gas is used to generate steam and then electric power. This method of power generation is 50% more efficient when compared to burning LBG in a boiler to generate steam and then electric power. In addition, the present invention minimizes polluting storage yards and transportation of coke by mechanical means, e.g., conveyor systems, as would be necessary if a fluid coker were associated with a neighboring CFB boiler plant rather than being directly connected to it via transfer lines, as is the case in the present invention.

While the invention has been described herein by way of an example in connection with what are, at present, considered to be the most preferred embodiments of fluid coking, it is to be understood that the invention is not limited to the disclosed embodiment, but is intended to cover various combinations or modifications of its features and several other applications included within the scope of the invention as defined in the appended claims.

1. A system for converting a heavy oil feed to light hydrocarbons and electric power, comprising:
a reactor comprising:
a coking zone containing a fluidized bed of solid particles, into which the heavy oil feed is introduced and subjected to thermal cracking to form light hydrocarbon vapors and coke particles with hydrocarbons adhered thereto;
a scrubbing zone, located above the coking zone, for scrubbing the light hydrocarbon vapors; and
a stripping zone, located at the bottom of the coking zone, for stripping at least a portion of hydrocarbons adhered to the coke particles to form stripped coke particles;
a furnace connected to the stripping zone for receiving at least a portion of the stripped coke particles, in which the stripped coke particles are combusted to form a stream comprised of flue gas and coke fines;
at least one fines separator connected to the furnace for receiving at least a portion of the stream formed in the furnace and separating the coke fines from the flue gas;
at least one heat-exchange means for exchanging the heat of the separated flue gas with water and/or steam to form heated steam for generation of electric power.

2. The system of claim 1 further comprising a conduit for recycling at least a portion of the coke fines from the furnace to the coking zone.

3. The system of claim 1 further comprising a conduit for recycling at least a portion of the coke fines from the furnace to the stripping zone.

4. The system of claim 1, wherein the stripping zone comprises a baffle for inhibiting recirculation of coke particles from the stripping zone to the coking zone.

5. The system of claim 1 further comprising a conduit for recycling at least a portion of the separated coke fines from the fine separator to the furnace.

6. The system of claim 1, wherein the stripped coke particles are introduced to the furnace at its lower portion and combusted in an upward flow of combustion air.

7. The system of claim 1, wherein the fines separator is connected to the upper portion of the furnace.

8. The system of claim 1, wherein the fine separator is a cyclone.

9. The system of claim 1 further comprising a steam turbine generator for generating electric power from steam.

10. A process for converting a heavy oil feed to light hydrocarbons and electric power, comprising the following steps:
(i) introducing a heavy oil feed into a coking zone containing a fluidized bed of solid particles and subjecting the feed to thermal coking conditions in the coking zone to produce light hydrocarbon vapors and coke particles with hydrocarbons adhered thereto;
(ii) passing at least a portion of the light hydrocarbons vapors through a scrubbing zone to scrub the light hydrocarbons vapors;(iii) passing the coke particles from the coking zone to a stripping zone and stripping the hydrocarbons adhered to the coke particles to form stripped coke particles,
(iv) passing the stripped coke particles to a furnace and combusting at least a portion of the stripped coke particles to form a stream comprised of flue gas and coke fines;
(v) passing at least a portion of the stream of step (iii) to a fines separator and separating the uncombusted coke particles and/or coke fines from the flue gas in the stream; and
(vi) passing the separated flue gas from the fines separator to a heat-exchange means and exchanging the heat of the flue gas with water and/or steam to form a heated steam for electric power generation.

11. The process of claim 10 further comprising recycling at least a portion of the coke fines from the furnace to the coking zone or the stripping zone.

12. The process of claim 10, wherein the stripped coke particles are introduced to the furnace at its lower portion and combusted in an upward flow of combustion air.

13. The process of claim 10, wherein the solid particles comprise coke particles produced in the coking zone.

14. The process of claim 10, wherein the solid particles comprise coke fines recycled from the furnace.

15. The process of claim 10, wherein the temperature of the stripping zone is higher than the temperature of the coking zone.

16. The process of claim 15, wherein the temperature of the stripping zone is 5to 15° C. higher than the temperature of the coking zone.

17. The process of claim 10 comprising introduction of a limestone to the furnace.

18. The process of claim 10, wherein the combustion rate of the coke particles in the furnace is at least 95%.

19. The process of claim 10 comprising controlling the temperature of the furnace using in situ steam generation.

20. The process of claim 19, further comprising generating electric power from the heated steam of step (vi).
